(19) United States
(12) Patent Application Publication
(10) Pub. No.: US 2003/0089803 A1
(43) Pub. Date: May 15, 2003

(54) Drip irrigation hose with emitters having different discharge rates

(76) Inventor: Mark Huntley, San Diego, CA (US)

Correspondence Address: CHRISTIE, PARKER & HALE, LLP, P.O. BOX 7068, PASADENA, CA, 91109-7068, US

(21) Appl. No.: 10/324,708

(22) Filed: Dec. 19, 2002

Related U.S. Application Data
(63) Continuation-in-part of application No. 10/020,006, filed on Oct. 30, 2001.
Application No. 10/020,006 is a continuation of application No. 09/443,561, filed on Nov. 19, 1999, now Pat. No. 6,308,902.
(60) Provisional application No. 60/394,218, filed on Jul. 5, 2002.

(51) Int. Cl. B05B 15/00

(52) U.S. Cl. 239/542

(57) ABSTRACT

An improved drip irrigation hose is provided. The hose has a water supply passage and a plurality of flow regulating channels manufactured into the hose that are smaller than the water supply passage. The flow regulating channels each comprise a predesignated geometry to provide a desired discharge rate at a given pressure, an inlet section comprising one or more openings connecting the water supply passage to that flow regulating channel, and an outlet section comprising one or more openings connecting that flow regulating channel to the exterior of the hose. The plurality of flow regulating channels have at least two different geometries to provide at least two different discharge rates at the given pressure field. This invention has value to the irrigation designer in that it allows the designer to select emitter characteristics depending on the position of the emitter in the field.

### CROSS-REFERENCE TO RELATED APPLICATIONS

This application is a continuation-in-part of application Ser. No. 10/020,006, filed Oct. 30, 2001, which is a continuation of application Ser. No. 09/443,561, filed Nov. 19, 1999 (now U.S. Pat. No. 6,308,902). This application also claims the benefit of the filing date of Provisional Application No. 60/394,218, filed Jul. 5, 2002. The disclosures of each of the listed applications are incorporated fully herein by reference.

### BACKGROUND OF THE INVENTION

Drip irrigation systems have come into widespread use in the agricultural area. Drip irrigation systems supply water at a slow, controlled rate to the root zone of the particular plants being irrigated. Typically, drip irrigation is accomplished by providing a low volume water outlet at each plant that permits a limited dripping of water directly to the root zone of the particular plant. Because evaporation, runoff, overwatering, and watering beyond the root zone are eliminated, substantial water and nutrient savings are realized. In addition, drip irrigation reduces contaminants to the water table by enabling the farmer to supply only enough water and fertilizer to reach the plants, reducing excess water that would run off and contaminate the water table below.

Drip irrigation hoses tend to be relatively long to be able to extend across a field. As the water travels along the hose away from the water source, the pressure of the water decreases. Thus, the water pressure at the beginning of the hose (near the water source) is greater than that at the far end of the hose. Because the drip rate of the hose is a function of the water pressure, the drip rate at the beginning of the hose tends to be greater than at the end of the hose. Other field conditions, such as elevation, also affect the pressure, and thus the drip rate, along the length of the hose. However, it is often desirable to have a relatively uniform drip rate along the length of the hose. Moreover, other varying field conditions, such as soil type and drainage, create a need to have different drip rates throughout the field to compensate for the different field conditions.

One proposed solution to the pressure variation problems is to incorporate pressure-compensating emitters into the hoses to reduce the effect of the pressure difference over the length of the hose on the drip rate along the length of the hose. Such hoses are described in U. S. patent application Ser. No. 09/308,060, entitled “Pressure-Compensating Drip Irrigation Hose and Method for Its Manufacture”. However, although these designs address certain pressure-compensation issues, they do not provide a way to provide predetermined drip rates that vary along the hose.

### SUMMARY OF THE INVENTION

According to the invention, the flow discharge characteristics of drip irrigation hose such as flow discharge rates and emitter spacing are matched to the conditions of a field in which the hose is installed such as elevation and soil porosity.

In one aspect of the invention, the field is mapped so the location of each area of the field is uniquely identified. The field conditions of each such area are determined by measurement or pre-existing data about the field and a data base is constructed. The data base links the mapped field areas to the corresponding field conditions. For example, using the above terminology, row 1, point a is mapped to one field elevation in the data base, row 1, point b is mapped to another field elevation, etc. As the hose is manufactured, the flow discharge characteristics along its length are designed to provide the desired flow to each field area based on the field conditions stored in the data base for that field area. For example, if uniform irrigation throughout the entire field is the goal, the flow discharge rate of the portion of hose to be laid at row 1, point a is designed to be equal to that at row 1, point b, etc., based on the elevation differences reflected by the data base values.

In another aspect of the invention, a drip irrigation hose is marked to identify field areas (locations) as the hose is manufactured. This facilities installation of the hose in field areas for which the flow discharge characteristics of the hose are designed.

In still another aspect of the invention, a field is mapped so the location of each area of the field is uniquely identified. A drip irrigation hose is designed to have flow discharge characteristics that are matched to areas of the field. These matched field areas are marked on the hose. As the hose is installed, the actual location of the hose in the mapped field is compared with the marks on the hose so the hose is laid down as designed. In one embodiment, the field areas and the marks on the hose are visible to the eye so the comparision can be made by a human in the course of installation.

### DESCRIPTION OF THE DRAWINGS

These and other features and advantages of the present invention will be better understood by reference to the following detailed description when considered in conjunction with the accompanying drawings wherein:

FIG. 1 is a cross-sectional view of a drip irrigation hose having a flow regulating channel between its margins.

FIG. 2 is a top sectional view of a flow regulating channel according to the invention.

FIG. 3 is a schematic block diagram of the method for making a drip irrigation hose of the continuous emitter type.

FIG. 4 is a schematic view of a portion of the film path for making a drip irrigation hose in accordance with the invention.

FIG. 5 is a block diagram that illustrates how a drip irrigation hose having different discharge rates matched to the field conditions can be made.

### DETAILED DESCRIPTION

The invention deals with drip irrigation hose having a series of emitters that differ in geometry to provide different discharge rates throughout a field. Preferably, the hose has emitter discharge rates adjusted to conform to specific irrigation needs and field conditions at particular locations in a field layout.

Specific emitter characteristics are provided on the hoses to assist the farmer with installation. Generally the hose is provided to the farmer in rolls. Information is put on the rolls in such a way as to account for specific customer installation patterns. For example, the information would recite “lay down four parallel rows driving away from the water header, skip four rows, and drive back towards the water header.” Other installation could information could be provided as desired.

A system is disclosed that stores customer field information, such as topography, soil conditions, and drainage requirements, for purposes of providing customer specific irrigation products on a periodic basis. Additionally, the system can automatically update customer specific irrigation products in response to crop yield information (provided by satellite sensing, airborne sensing, or other means), or in response to changes in crops planted.

The disclosed manufacturing process allows sales managers, dealers, customers or other personnel to use software to convert field characteristic data into specific irrigation layout designs, which are fed electronically to the hose manufacturing equipment, and customer specific product is automatically produced. Field characteristic data includes, but is not limited to, soil conditions, target flow rates, installation patterns, topography, and crops planted.

The uniformity of the discharge rate of irrigation hose is also improved by controlling the flow rate of the header pipe, to which the individual irrigation hoses are connected. In one embodiment, the header pipe is designed to selectively deploy different flow rates to the individual hoses that extend throughout the field. Selective deployment of different flow rates is accomplished by varying the geometry, e.g., the cross-sectional area, of the header pipe.

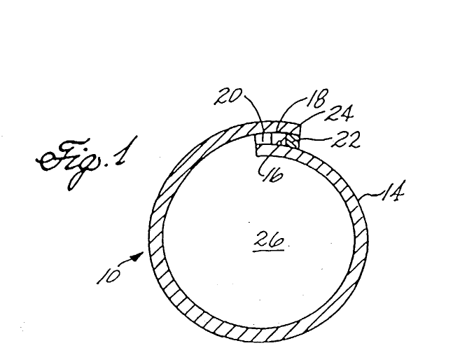

As shown in FIG. 1, a flexible drip irrigation hose 10 (commonly referred to as “tape”) is made from an elongated strip of plastic film 14, which is typically 4 to 15 mil thick. The film 14 can be made of any suitable material, for example, a laminate of high density polyethylene or polypropylene. Film 14 is folded longitudinally to form overlapping inner and outer longitudinal margins 16 and 18, thus creating a seam. A first longitudinal rib 20 partially seals margins 16 and 18. A second longitudinal rib 22, outboard of rib 20, completely seals margins 16 and 18. Ribs 20 and 22 contain a repeating longitudinal pattern that defines a series of small flow regulating channels 24 along the length of the hose 10. By virtue of the longitudinal fold in film 14, the interior surface of film 14 defines a relatively large water supply passage 26. The water supply passage 26 is connected to a source of water under pressure, not shown. Examples of such constructions are described in U.S. Pat. Nos. 4,247,051, 4,984,739, 5,282,578, and 5,522,551, the disclosures of which are incorporated herein by reference.

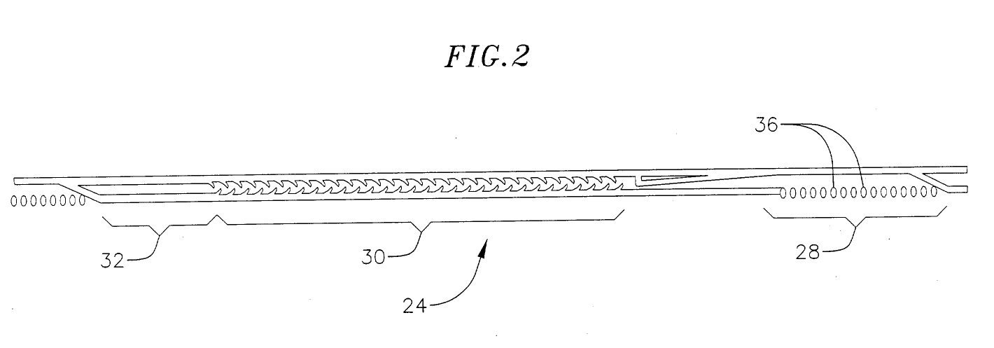

As shown in FIG. 2, the flow regulating channels 24 (i.e., emitter regions) each have an inlet section 28, a turbulent flow section 30, and an outlet section 32. For each flow regulating channel 24, the inlet section 28 comprises one or more inlet openings to allow water to flow from the water supply passage 26 into the flow regulating channel 24. In the depicted embodiment, the inlet section 28 comprises a plurality of pillars 36 between which are formed openings 38. As would be recognized by one skilled in the art, the inlet section 28 can have any other design that permits water to enter the flow regulating channel 24 from the water supply passage 26.

The flow regulating channels 24 each have a much smaller cross-sectional area than the water supply passage 26. The cross-sectional area of the water supply passage 26 is preferably from about 20 to 300 times, more preferably from about 50 to 200 times, larger than the cross-sectional area of the flow regulating channel 24. Accordingly, each flow regulating channel 24 creates a passage between the water supply passage 26 and the outside of the hose 10 that controls the flow rate of the water flowing through it.

The flow regulating channels 24 can have any other design as is known in the art. For example, the turbulent flow section 30 can be formed of a series of chevrons, by a series of walls that form a serpentine path, or by any other configuration that creates turbulent flow. However, the turbulent flow section can be omitted if desired and replaced with a straight-path channel.

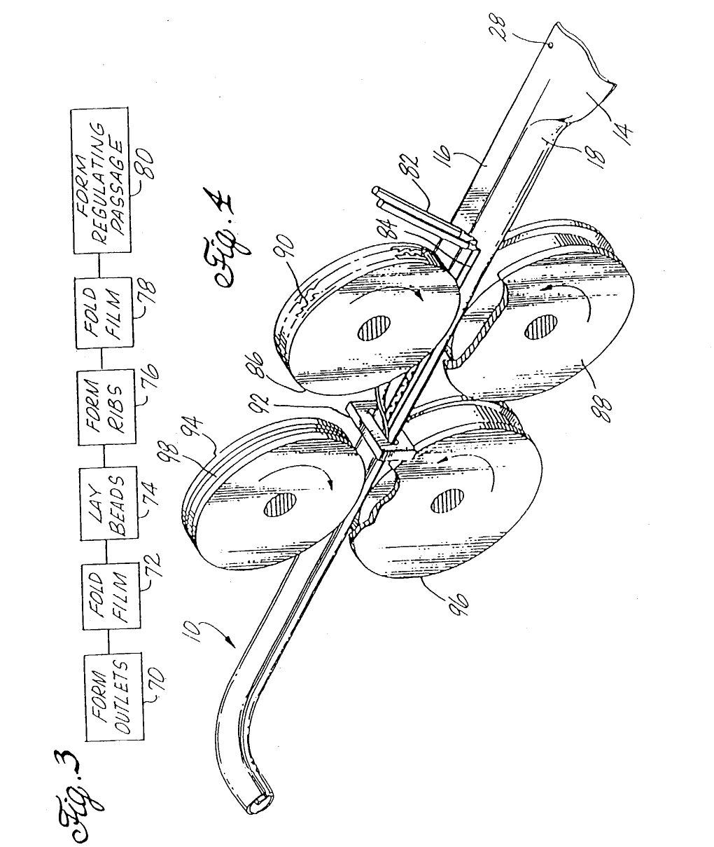

FIGS. 3 and 4 depict a method for making the drip irrigation hose shown in FIG. 1. As represented by a block 70, the outlets 44 are first formed in film 14. Preferably each outlet 44 comprises a single longitudinal slit in the film 14. A preferred method and apparatus for forming such a knife-formed slit outlet is described in U.S. Pat. No. 5,522,551, the disclosure of which is incorporated herein by reference. Any other suitable method known in the art for providing outlets can also be used.

As represented by block 72, the inner margin 16 is then folded. As represented by block 74, one or more beads are laid on the outside surface of the inner margin 14 by one or more extrusion nozzles. As represented by block 76, a pattern is formed in ribs 20 and 22 by a molding wheel. As represented by block 78, outer margin 18 is then folded onto inner margin 16, with the formed ribs therebetween. Finally, as represented by block 80, flow regulating passage 24 is finished by passing inner margin 16, outer margin 18, and the ribs 20 and 22 through the nip of a form wheel and a backing wheel to set precisely the height of the ribs.

FIG. 4 illustrates an assembly station for performing the above-described steps. One or more extrusion nozzles 82 deposit one or more continuous longitudinal beads 84 (in the form of hot molten glue or resin) on the outside surface of the inner margin 16. The film 14 is passed through the nip of a rotating molding wheel 86 and a rotating backing wheel 88. The molding wheel 86 contains a pattern of depressions 90 corresponding to the desired raised rib pattern, i.e., a pattern such as that shown in FIG. 2. In the nip, beads 84 are shaped by molding wheel 86 to form the desired bead pattern on film 14 for the entire length of the hose 10. After leaving the nip of wheels 86 and 88, the external margin 18 of the film 14 is folded by a guide 92 to overlap the inner margin 16. Finally, the overlapped margins of the film 14 pass through the nip of a form wheel 94 and a second backing wheel 96. The form wheel 94 has a groove 98 that depresses the ribs formed by the beads 84 to set the rib height at a specified value that determines the flow rate of the hose 10. During the described process, the film 14 is continuously transported by a conventional means, not shown. For example, the disclosed wheels could be driven, or other drive wheels could be provided, to transport the film.

In a preferred embodiment, as the hose is being made, the height or width of each flow regulating channel 24 is adjusted on an individual basis using a track controller. The track controller is a device that shapes the final height or spacing of the bead pattern, and thus the cross-sectional area of the flow regulating channels, by passing between two rollers. The space between the rollers is adjusted by controlling the position of one of the rollers with an electronically-controlled linear actuator. The input signal to the actuator is provided by the track controller, which is programmed to correspond to a signal from a footage counter locating the position on the hose. It is important to control the amount of glue extruded to form the beads to ensure that glue starvation is not an issue. To this end the extruder output is also regulated by the track controller.

As would be recognized by one skilled in the art, other aspects of the flow regulating channel 24 geometry can be changed in addition to or instead of the height, such as the width of the flow regulating channel, the size of the inlets openings, the size of the outlets 44, the number and/or arrangement of the chevrons in the turbulent flow section 30 or the length of the turbulent flow section. For example, as the length of the turbulent flow section is increased, the pressure drop across the turbulent flow section will increase. For convenience, the flow regulating channels 24 can be numbered (or otherwise indicated or coded) and the corresponding track height (or other geometry variation), and therefore discharge rate, can be identified with a particular position on the hose 10.

The information for adjusting the geometry of the flow regulating channels 24 can be provided in any suitable manner. In one embodiment, GPS (global position satellite) mapping techniques are used to map the topography of the field in which the hose is to be placed. The GPS map can be sent electronically to the computer and can be used to send information to the track controller. Additionally, the GPS map configuration can be fed into the assembly machine computer to place position identifying marks along the hose and/or automatically mark information, such as “roll # of a total # of rolls”, on the hose so that the farmer can distinguish between the rolls for proper placement in the field. The track controller change being linked to the footage counter provides the information required by the assembly machine computer to place position identifying marks along the hose or to make labels according to the product and product section made. Other surveying techniques could be similarly used to provide a map of the field.

Also, as would be recognized by one skilled in the art, the flow regulating channels 24 need not be formed in the margins 16 and 18 of the hose 10, but can be provided at any location on the hose. For example, it is known in the art to provide discrete flexible emitters (not shown) that are adhered or otherwise bonded to the interior or exterior of the hose, with each emitter having a flow regulating channel 24 as described above. For example, flexible discrete external emitters can be adhered to the exterior of the hose, as described in U.S. patent application Ser. No. 09/136,354, entitled “External Emitter for Drip Irrigation Hose”, the disclosure of which is incorporated by reference. Alternatively, emitters can be penetrably mounted within the wall of the hose, as described in U.S. Pat. Nos. 4,850,531, 4,077,570 and 3,970,251, the disclosures of which are incorporated herein by reference. In accordance with the invention, a number of discrete emitters (i.e., flow regulating channels) having different geometries are preferably manufactured into the hose to provide a complete product to the farmer. In other words, the hose is designed and manufactured to conform to a farmer's particular field conditions so that the farmer can simply lay the hose without having to insert or replace the emitters to achieve the desired drip rates. The emitters having different geometries can be made by any method known to those skilled in the art, such as injection, insert, or sequential molding. The hose (or tape) can also be manufactured by any method known in the art, such as by providing a film with overlapping margins, as described above, or by extrusion. The emitters can then be attached to the inside or outside of the hose by any of several methods including, but not limited to, adhesive bonding, solvent bonding, thermal bonding, ultrasonic welding and penetration. The emitters are attached to the hose so that an emitter having a given geometry (and therefore a given drip rate at a certain pressure) is provided in a location on the hose that will ultimately be placed in a location in a field having conditions that correspond to the given drip rate.

Alternatively, a continuous emitter can be bonded to the hose, where the continuous emitter has a series of flow regulating channels 24 along its length. In this embodiment, the continuous emitter can be pre-formed having flow regulating channels 24 having varying geometries, e.g., varying height, width, inlet size or outlet size, as desired for a particular field. The pre-formed continuous emitter can then be manufactured into the irrigation hose by bonding it to the hose in any suitable manner known in the art. For example, the emitter can be extruded and formed by means of an embossing or imprinting tool. This technique is particularly useful if the hose is also being extruded. Thus, a continuous emitter could be extruded and formed, then inserted into a die center around which a hose is extruded. As the emitter and hose are extruded together, the emitter would be formed and adhered to the hose before it is cooled. Alternatively, the continuous emitter could be extruded and formed offline, and then fed through a hole in the die through which a hose is extruded. In another embodiment, the continuous emitter could be fed and joined to a long continuous strip that is then folded to form a hose.

In another embodiment, the drip irrigation hose is a hard hose having a plurality of discrete emitters (i.e., flow regulating channels) provided therein, as is known in the art and described, for example, in U.S. Pat. Nos. 5,111,996 and 4,824,025. In accordance with the invention, the emitters can have varying geometries, for example, from five to fifteen different geometries, to provide for different drip rates. As the hard hose is extruded, the emitters having different geometries are inserted into the hose in a predetermined order so that the emitters are positioned in the hose to correspond to the field conditions in the field in which the hose is to be placed.

Preferably, regardless of the type of emitter used, the emitter characteristics or ratings are varied under computer control during manufacture to match the field location where the segment of hose in question is to be laid in the course of its installation. The field where the hose is to be laid is mapped so each area of the field is uniquely identified. The mapped areas of the field and the length of hose to be installed in the field are marked according to this identification. For example, one corner of the field could be marked as row 1, point a . . . , to point n at the other end of the field; Next to row 1, is row 2, point a, . . . , to point n at the other end of the field, etc. to row n. Thus, a visible grid of rows and columns of points is formed on the field to assist the field workers lay the hose so the positions of its emitters are congruent with the positions of the field where the emitters are supposed to be according to their discharge rates. The hose is marked by the computer in coordination with the control of the discharge rate. As a result, the field workers can proper lay the hose by matching the markings on the hose with the markings on the field.

The invention is not limited to fixed geometry emitters over the length of the hose, but also allows for varying geometry (pressure-compensating) emitters with different target flows positioned along the run. A combination of these concepts is useful, for example, where the geometry of the emitters is altered to account for changes in soil conditions and the emitters are also pressure-compensating to account for changes in pressure along the length of the hose.

The inventive hoses have numerous applications. The invention permits customer-unique irrigation products using specific flow rate emitters with different flow rates positioned specifically over the length of a customer's run as a means of accommodating changes in elevation or as a means of accommodating changes in supply pressure over the specific length of the run. For example, the hose can be designed to gradually increase the output towards the end of the run to compensate for pressure decreases along the run. This will allow the length of run to be extended while maintaining the distribution uniformity.

Additionally, customized hose can be made to have different sections with different flows to account for variations in soil conditions or crop requirements. Sandy soil may require higher flow than would clay soil. With the farmer being able to plot GPS maps of their field and identify different soil characteristics, a custom tape can be made to match the different flow requirements of that field. In addition to varying emitter flow rates, variations in emitter spacing may be employed as a means of accounting for customer unique requirements. For example, a denser population of lower flow emitters may be provided if advantageous for specific soil conditions.

Moreover, non-customer specific irrigation products could be designed that use fixed geometry emitters of varying flow rate capabilities specifically positioned over the length of a run as a means of accommodating changes in pressure along a level or slightly sloping run.

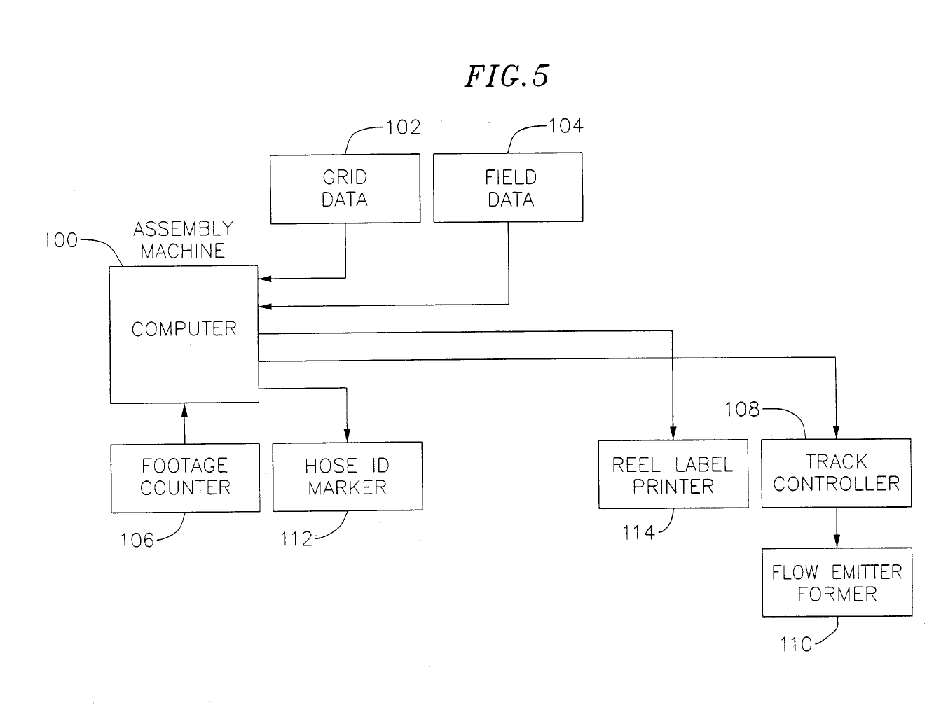

In one embodiment of the invention illustrated in FIG. 5, an assembly machine computer 100 is programmed to control the hose assembly operations represented in FIG. 3, to form emitters in the hose having different discharge rates depending upon the characteristics of the field in which the hose is installed, and to mark the hose to designate where the emitters should be installed in the field to match the field conditions. Prior to hose installation, the field to be irrigated is segmented into a grid of X and Y coordinates by surveying or another well-know technique. The field conditions at each point of the grid are also measured. This could be done manually or automatically. Visible grid markers are placed in the field at the grid points to apprise a tractor operator where the operator is located in the field. As represented by a block 102 labeled “grid data” and a block 104 labeled “field data”, these field conditions, as they are measured, and their respective grid coordinates are coupled to computer 100, where they are stored in linked fashion. If the field conditions comprise elevation, the altitude of the field at the grid points would preferably be measured automatically as a tractor traverses the field. If the field conditions comprise the degree of soil moisture retention (e.g., of sandy soil or clay), plugs would preferably be extracted at the grid points and tested manually. If the field conditions comprise the degree of drainage, a moisture probe would preferably be inserted in the soil manually at the grid points. If the field conditions comprise crop type, they are dependent upon past experience.

A footage counter 106 is disposed in the hose path of the assembly equipment shown in FIG. 4. Footage counter 106 could for example sense the rotation of either the hose assembly or transport wheel such as wheel 90. This rotation is proportional to the linear displacement of the hose being processed. Taking the grid data from block 102 and the field data from block 104, computer 100 calculates the relative locations along the length of the hose being assembled where the emitters are to be placed and their discharge rates and compares these locations with the output from footage counter 106 to determine the absolute locations. Similarly, the readings from footage counter 106 inform a flow emitter former 110 and a hose ID marker 112 where their operations should take place along the length of the hose being assembled.

Computer 100 is programmed to drive a track controller 108, which operates flow emitter former 110. As described above, former 110 varies the geometry and, thus the flow discharge rate, of the hose being assembled, depending upon the field conditions fed to computer 100 by field data from block 104 and the linear position of the hose fed to computer 100 by footage counter 106. For example, if the height of the flow regulating channel is to be varied, the spacing between the height determining rollers is adjusted responsive to a comparison between the calculated hose locations and the output of footage counter 106.

Computer 100 is also programmed to generate identifying marks along the length of the hose being manufactured. For this purpose computer 100 drives a hose ID marker 112 such as a printer. Hose ID marker 112 also operates responsive to a comparison between the calculated hose locations and the output of footage counter 106. The ID markers can be machine readable (e.g. UPC marks) so the ID markers are displayed on a screen to orient the hose in the field. Typically, the ID markers match the respective grid points. In other words, when an ID marker is identical to a grid point, the discharge rate of the emitter(s) it identifies is properly positioned in the field.

Computer 100 is also programmed to assign serial numbers to the reels about which the hose is wound for shipment, storage, and installation. In this case, all the emitters on a reel preferably have the same discharge rate and the field area to be covered by the hose on the reel is treated, in essence, as a single grid point having the same field conditions. A reel label printer 114 is driven by computer 100 to print the serial numbers on the respective reels. Label printer 114 also operates responsive to a comparison between the calculated hose locations and the output of footage counter 106. After the labels are printed, they are each applied to the corresponding reel. Preferably, the boundaries of the field areas are visually marked on the field or determined from the GPS signal, so they can be verified by the installer. The installer selects the reel corresponding to each field area and covers the area with hose from the selected reel.

Reel numbers can also be used to identify hose having different discharge rates and hose ID marks, to insure that the proper reel is selected for the area of the field it has been designed to irrigate. Thus, if an area of the field is defined by specific X and Y coordinates, the X and Y coordinates of the reel should correspond to the defined coordinates.

After assembly of the hose as described in connection with FIG. 5, a reel of hose is mounted on a tractor and the hose is paid out as the tractor traverses the mapped field. The tractor operator observes the visible grid markers on the hose and lays down the hose so the identifying marks on the hose and/or the reels match the grid markers. Instead of observing visible grid markers, the field location could be determined by GPS techniques.

If desired, reel serial numbers could be printed on the hose in addition to the identifying markers to insure that the reels are installed in the field in the proper sequence. The reel serial numbers on the hose could also provide a coarse check that the tractor is laying the hose in the proper position.

In its broadest aspect, he term “field conditions” is used herein to cover all parameters or characteristics that would dictate different discharge rates in a drip irrigation setting. This includes, but is not limited to, elevation, moisture retention, drainage, and crop type.

As a substitute for surveying, the X and Y coordinates could be generated by GPS mapping of the field.

The above-described embodiments of the invention are only considered to be preferred and illustrative of the inventive concepts. The scope of the invention is not to be restricted to such embodiments. Various and numerous other arrangements may be devised by one skilled in the art without departing from the spirit and scope of the invention.

1. A method for delivering water to a field having irrigation affecting characteristics that vary over the surface of the field, the method comprising the steps of:
mapping the field so each area of the field and its conditions are uniquely identified;
placing along the length of a drip irrigation hose flow emitters that match the mapped field conditions;
placing along the length of the hose identifying marks that match the mapped areas of the field; and
laying the hose down on the field so the identifying marks are congruent with the mapped areas.

2. The method of claim 1, in which the field mapping step establishes a visible grid on the surface of the field.

3. The method of claim 2, in which the mapping step uses GPS data.

4. The method of claim 3, in which the laying step comprises comparing the visible grid and the identifying marks and positioning the marks based on the comparison.

5. The method of claim 2, in which the laying step comprises comparing the visible grid and the identifying marks and positioning the marks based on the comparison.

6. The method of claim 1 in which the conditions of the field comprise topography.

7. The method of claim 1 in which the conditions of the field comprise soil conditions.

8. The method of claim 1 in which the conditions of the field comprise drainage conditions.

9. The method of claim 1 in which the conditions of the field comprise the type of planted crop.

10. The method of claim 1 in which the conditions of the field comprise the installation pattern.

11. The method of claim 1, in which the step of placing identifying marks along the length of the hose is controlled by a footage counter.

12. A method for manufacturing drip irrigation hose having flow emitters along its length that match flow requirements over the surface of a field, the method comprising the steps of:
generating a first data set representing surface positions on the field;
generating a second data set representing field conditions;
calculating along the length of the hose from the first and second data sets, characteristics of the flow emitters and their locations required to meet the flow requirements,
making drip irrigation hose having flow emitters with the calculated characteristics and locations along the length of the hose; and
placing along the length of the hose marks identifying surface positions on the field corresponding to the first data set.

13. The method of claim 12, in which the calculating step is performed with a computer.

14. The method of claim 13, in which the making step makes drip irrigation hose having flow emitters with variable flow rates.

15. The method of claim 12, in which the making step makes drip irrigation hose having flow emitters with variable spacing.

16. The method of claim 12, in which the making step comprises forming at least two plastic beads along one margin of a strip of plastic material, folding the strip so the margins overlap with the plastic beads between the margins; passing the folded strip between two precisely spaced rollers to form a flow regulating passage; and changing the spacing between the rollers to change the calculated characteristics of the flow emitters

17. The method of claim 12, in which the making step comprises forming at least two plastic beads along one margin of a strip of plastic material so the spacing between the beads varies to change the calculated characteristics of the flow emitters, folding the strip so the margins overlap with the plastic beads between the margins; passing the folded strip between two spaced rollers to form a flow regulating passage.

18. A method for installing on the surface of a field drip irrigation hose have flow emitters along its length comprising the steps of:
mapping the surface of the field so each area of the field is uniquely identified;
marking the hose with field areas; and
laying the hose down on the field so the marked field areas are congruent with the mapped areas.

19. A method for manufacturing drip irrigation hose for distributing water to a field:
mapping the field so each area of the field and its conditions are uniquely identified;
placing along the length of the drip irrigation hose flow emitters that match the mapped field conditions responsive to a footage counter, and
placing along the length of the hose identifying marks that match the mapped areas of the field.
